(19) United States
(12) Patent Application Publication
(10) Pub. No.: US 2008/0071201 A1
(43) Pub. Date: Mar. 20, 2008

(54) Simplified massage system of seat type

(76) Inventor: Horatiu Mircea Popescu, Sterling Heights, MI (US)

Correspondence Address: Horatiu Popescu, St. Paul Ave, Windsor, ON, N8S 4T6, US

(21) Appl. No.: 11/521,509

(22) Filed: Sep. 15, 2006

(51) Int. Cl. A61H 7/00

(52) U.S. Cl. 601/84; 601/86

(57) ABSTRACT

An assembly comprising of massage sub-assemblies, each one provided with contact components mounted on zigzag wire support, profile tube or rod, or flexible shaft and connected to an output shaft of a gearbox attached to the upper beam, is mounted to a seat frame between the upper and lower beams. When the system is provided with pressure adjustable device, the lower beam is suspended to vertical components pivoting on the sidewall of the seat frame. Two pressure adjustable cables are connected to the lower beam-ends, and press the massage assemblies through the seat-back cover mounted on the vertical components and moving synchronously with the system. The rotation of the massage assemblies modifies the contact points with the seat-back cover, creating a massage effect.

### TECHNICAL FIELD

This present invention particularly relates to a massage system of seat type, and more specifically, to a simplified mechanism providing one or two-directional movement maintaining the maximum area of effective massage on the seat back.

### BACKGROUND OF THE INVENTION

Massage systems for seats are typically built as flexible structures, attached to the seat frame by springs, elastic straps, or other flexible elements.

Prior known art describes a wide verity of massage systems for seats.

One solution is to build a sliding frame mounted on rails and electrically actuated up and down along these rails. The moving frame is provided with rollers that press out from inside the back cover of the seat.

The solution is not particularly efficient because of the size, weight and shape complexity of the frame, which prevent the mechanism from acquiring a satisfactory stroke length. Usually, the rollers and frame move back and forth with a span no bigger than a few inches.

Another solution for massage mechanisms for seats consists of a gearbox actuating two chains or timing belts, symmetrically opposite with respect to the gearbox location. The movement of the chains directs the up and down trajectory of a roller feature, traveling along the interior of the seat back.

The solution is unsatisfactory because of the complexity of the entire construction, as well as the weight, high cost and short stroke mechanism.

### SUMMARY OF THE INVENTION

Consequently, a simpler, cheaper, and lighter solution is desirable, with fewer components, such as a pair of pivoting subassemblies, equipped with plastic rollers, whose rotation induces movable contact points with the back of the seat. The solution may or may not provide adjustable pressure contacts.

This kind of mechanism systems are typically challenging to design because they are required to fit a limited space inside the seat, have adjustable pressure contact with the seat back, generate a long stroke to cover the entire length of the seat back, produce less noise and free play, and are also required to be cost competitive.

The current invention, as defined by the claims, provides a lighter construction assembly with fewer components, the massage subassemblies actuating the contact components by shape or cranks. It also provides solutions to adjust the contact pressure between the massage mechanisms and the inside surface of the seat back. The actuators transfer their adjusting movements through flexible cables, such as Bowden cables. The invention also provides a simplified fix solution, maintaining the maximized massage area on the seat back.

The present invention provides rollers mounted on flexible zigzag shaped wires to reduce the torque motion and to prevent the ware of the inside surface of the seat back in contact with the massage elements.

All the abovementioned features of the present invention, in relation to other concepts, advantages, and technical solutions, are easily apparent from the study of the invention's description, claims, and related drawings, where they are extensively explained.

### BRIEF DESCRIPTION OF THE DRAWINGS

FIG. 1 shows an isometric assembly view of the zigzag massage subassemblies assembled into the seat frame.

FIG. 2 shows the zigzag subassembly view and the location of the cross section through this subassembly

FIG. 3a shows a section view through a zigzag subassembly, when the rollers anchoring distribution area is in the same plane.

FIG. 3b shows a section view through a zigzag subassembly, when the rollers anchoring distribution area is along and around the zigzag wire support.

FIG. 4 shows a lower beam suspended by vertical components pivoting on each side frame of the seat.

FIG. 5 shows a massage subassembly which lower beam is suspended to the pressure adjustment cables.

FIG. 6 shows a cross section through the lower beam with no vertical suspension components.

FIG. 7 shows a massage assembly with stretching Bowden cables.

FIG. 8 shows a massage subassembly built with profile tubes or rods.

FIG. 9 shows a massage subassembly with contact components provided with side orientation features.

FIG. 10a shows a massage subassembly built with zigzag wires and cross pushers.

FIG. 10b shows a longitudinal section view of the massage subassembly built with zigzag wires and cross pushers.

FIG. 11 shows a massage system built with zigzag wires and transversal wire supports.

FIG. 12 shows a massage system imbedded in the foam pad of the seat.

### DETAILED DESCRIPTION OF THE PREFERRED EMBODIMENT

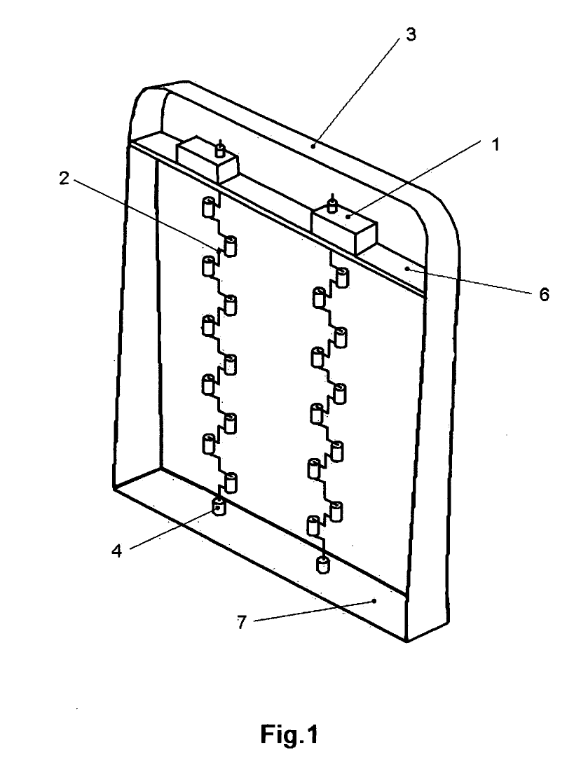

Referring to the drawings, FIG. 1 illustrates the massage system assembled into the seat in a functional position.

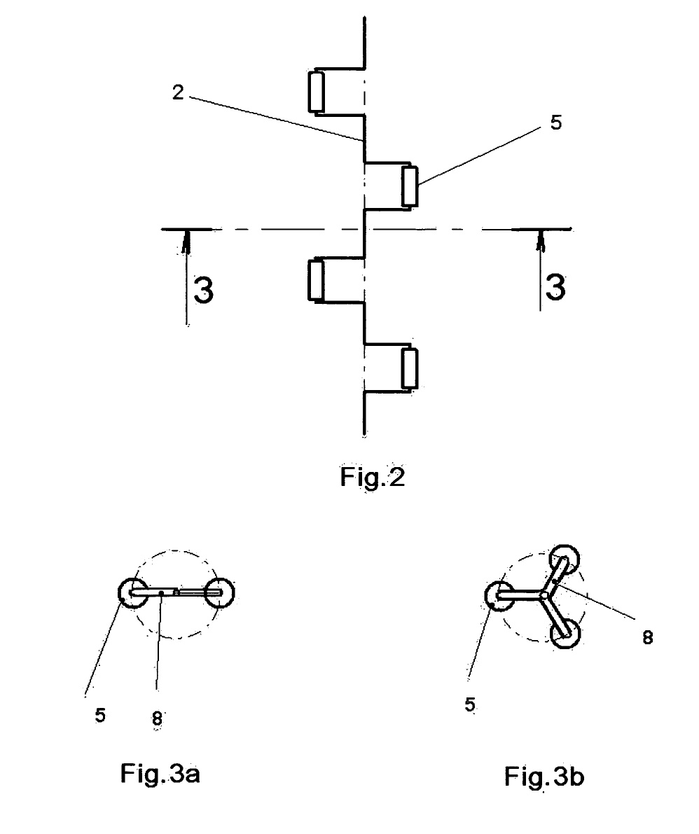

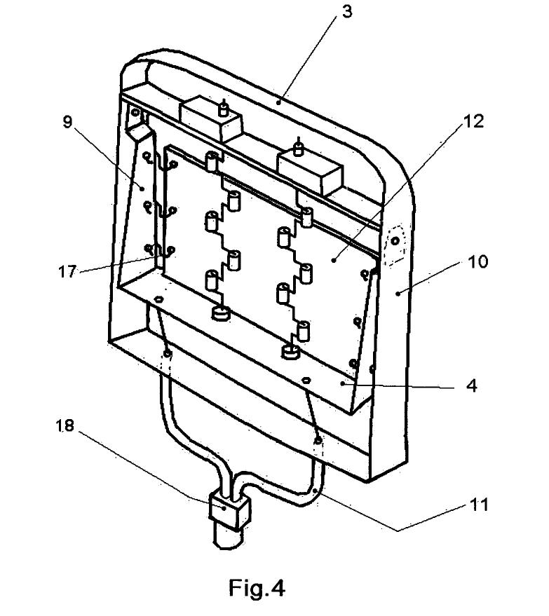

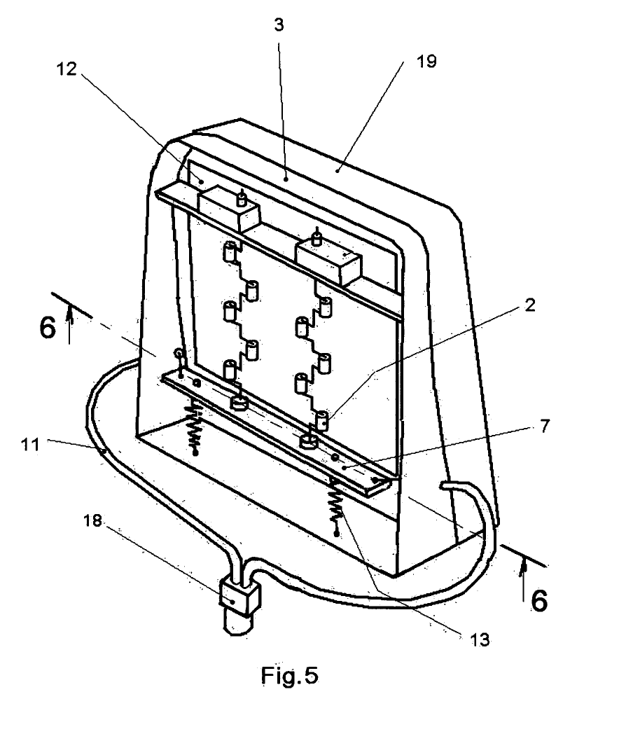

The massaging action is applied directly on the back pad of the seat or on its back cover 12 visible in FIG. 4, from the inside out, by rotating the zigzag assemblies 2 at constant or variable speed. During the rotation, each zigzag assembly has at least one contact point with the inside of the back cover 12. Through rotation, the contact points of the rollers, visible in FIG. 2 and FIG. 3, indent the cover of the seat back, and the bulges created execute the massage.

The system consists of a fix upper beam 6, a fix lower beam 7—both part of a seat frame 3, two gear boxes 1—actuating the massage subassembly 2 and mounted on the upper fix beam 6, and two lower bushings 4—mounted in the lower beam 7. In this case, the massage subassembly is represented by a zigzag wire support 8 with rollers 5—FIG. 2.

FIG. 2 describes the construction of a massage subassembly 2, detailing the shape and the position of the zigzag wire support 8, with respect to rollers 5—mounted along the wire support on different anchoring areas along the wire. The shape of the wire support 8 is holding the rollers 5 in place along the back, and generates the cranking pressure responsible for the massage effect of the device.

FIG. 3a and FIG. 3b illustrate a transversal section view through the massage subassembly 2, in which the disposition of the anchoring areas of the rollers along the zigzag wire 8 is in the same plane—as shown in FIG. 3a, or is evenly or unevenly spread around the rotation axis of the zigzag wire, and along the zigzag wire support 8—as shown in FIG. 3b.

In FIG. 4, the lower beam 4 is detached from the frame 3, and connected on each side to a vertical component 9, anchored on the beam and pivoting at the upper portion of the frame, on the frame sides 10—part of the seat frame 3. The vertical components 9 can be a wire, stamping, welded component, plastic molded component, or composite component, and allow the entire structure to be pushed against the back seat cover 12 for variable massage pressure. The back cover 12, provided with attachment elements 17 on each side, is mounted on the vertical components 9, and travels with them back and forth during the pressure adjustment process. The back cover 12 is attached to vertical components by sleeves, hooks, zippers, springs, etc, provided on each side.

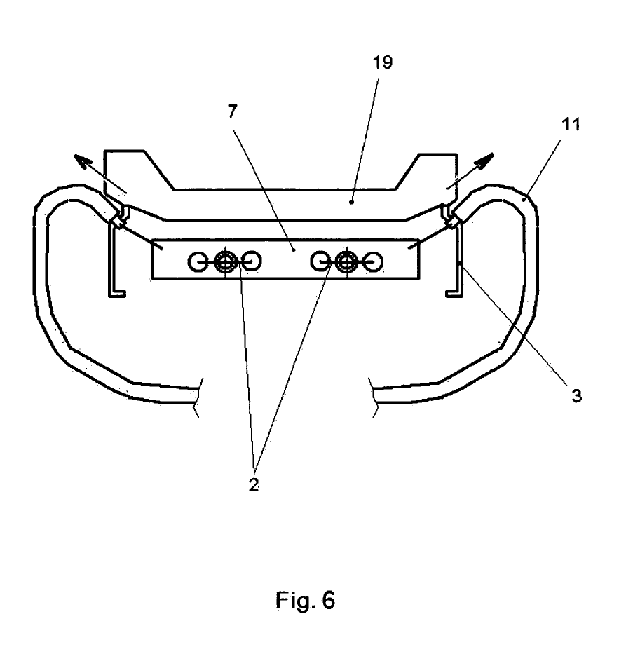

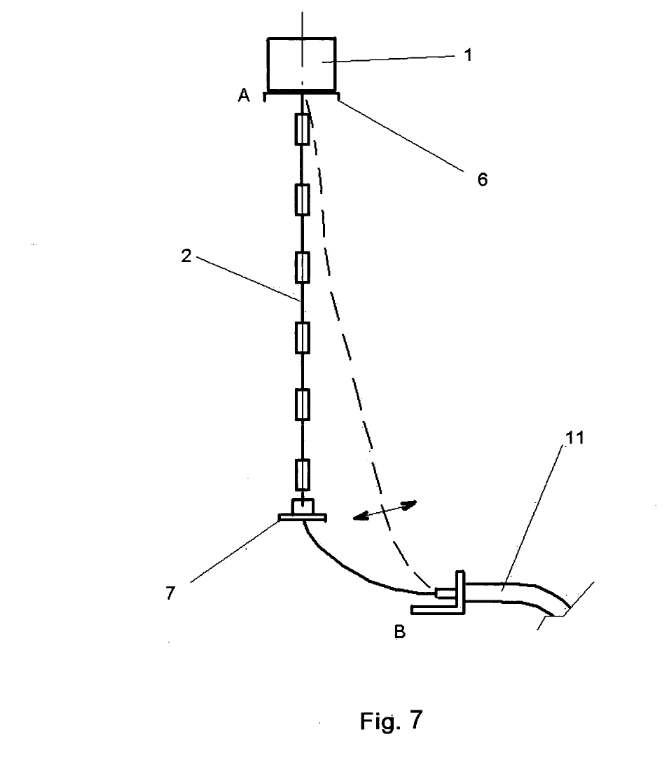

The adjusting system 18 is visible in FIG. 5, FIG. 6 and FIG. 7.

In FIG. 5, another solution is illustrated. The lower beam 7 is anchored on each side to a cable of a Bowden cable system 11, which pulls the massage subassemblies 2 against the back cover 12, this time mounted directly on the inner side of the back pad 19. The Bowden cables are mounted tangent to the beam, in horizontal direction. The necessary force to retract the massage subassemblies 2 at home position—which means no pressure on the back pad of the seat, is generated by the springs 13, anchored between the beam 7 and the seat frame 3. This solution eliminates the vertical components 9.

FIG. 6 represents a normal section through the system, at the lower beam level, and the arrows indicate the direction of the force of the cables 11, when the pressure is applied to the back cover of the seat.

FIG. 7 represents a solution in which the Bowden cable system 11 is oriented downward, the massage subassemblies 2 being stretched between the upper beam 6—represented by point A, and the anchor point on the frame of the Bowden cable system 11—represented by point B. No vertical components 9 necessary for this solution.

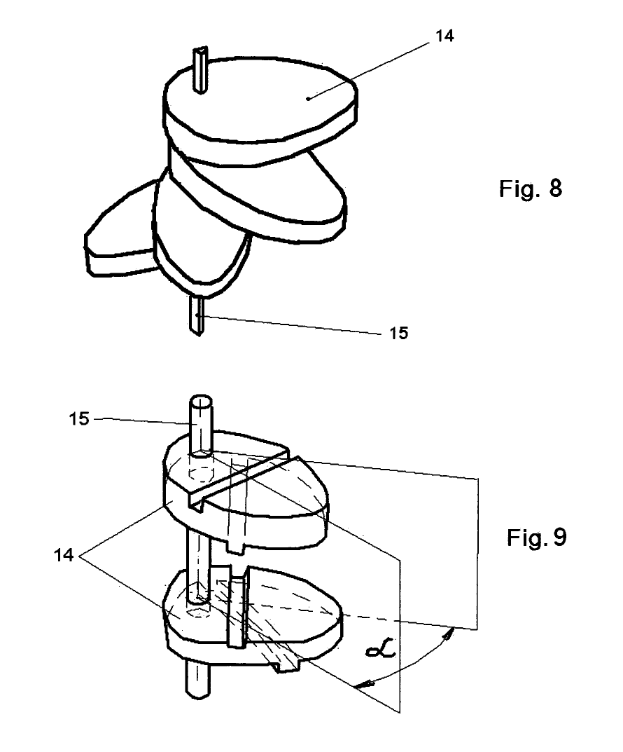

In FIG. 8, a particular solution of the massage subassembly 2 is illustrated.

The zigzag wire support 8 is replaced with a profile tube or rod 15, which outside shape is a triangle, square, rectangle, pentagon, etc. The geometric shape is capable of transferring torque to contact components 14, mounted along the tube 15. By rotation of the profile tube 15, the contact components 14—excentric with respect to the mounting hole on the tube 15, will rotate their protruding zone over the back cover 12, and generate the massage effect. The relative orientation of the shaped hole pierced in each contact component 14 varies from one component to another in such a way that, mounted together on the tube support 15, the protrusions assembly a specific space shape in contact with the back cover 12, varying the contact points along the back and during the rotation of the tube support 15.

In FIG. 9, the profile tube or rod 15 is round, and it is providing only the support for contact components 14.

These contact components have relative orientation features on each side, allowing to mount the contact components 14 one over the other only in a defined relative position. The picture shows the median planes of the two contact components in assembly position parted with α° angle.

The protruding feature of one side of a contact component fits to a mating groove on the opposite side of the adjacent contact component. Due to the relative orientation of the features of opposite sides of each component with respect to each other, two adjacent contact components 14, mounted on the wire support 15 and in contact with each other, will appear rotated along the wire support, and will generate a controlled relative orientation of the protruding zones of each one around the tube or rod 15.

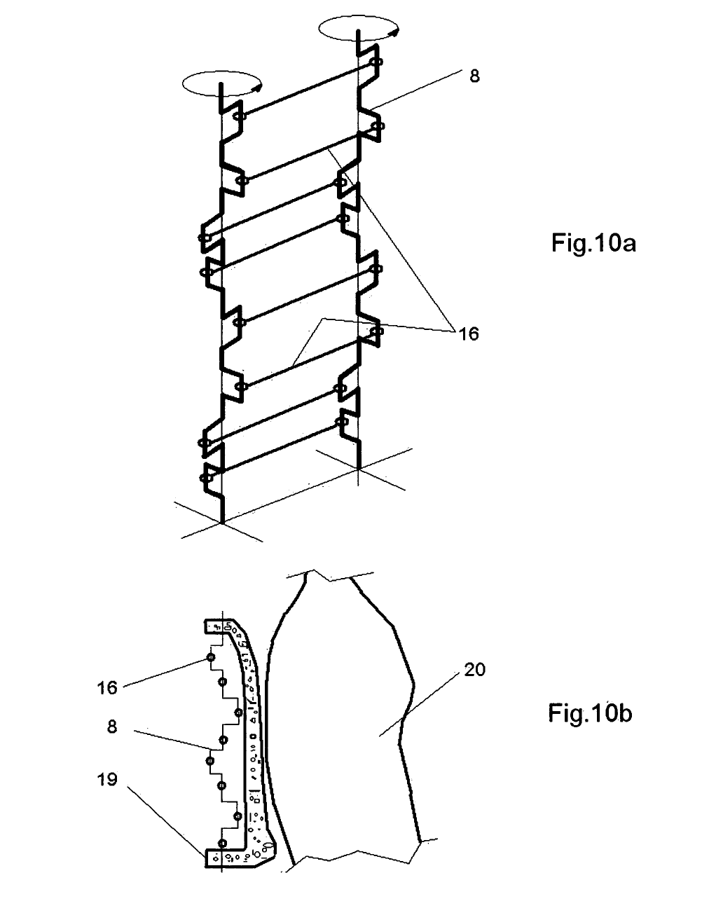

In FIG. 10a, the massage mechanism is composed of two identical zigzag wire supports 8, mounted on each frame side 10 of the frame 3. On each anchoring zigzag zone, correspondent to both zigzag wire supports, a cross pusher 16 is assembled. The two zigzag wire supports 8 will rotate synchronously or asynchronously, and the pushers 16 will move accordingly toward the occupant, generating variable alternating pressure zones along the back seat, producing in this way the massage effect. The pushers 16 can be a wire, a stamping, a plastic molded component, a welded component, a rubber component, a textile component, a glass component, a composite material component, a spring, etc., attached to the zigzag wires by hooks, bushings, sleeves, etc. To avoid the relative movement between the pushers 16, and the seat back cover 12—which can damage the back pad 19, special sleeves, foam, plastic case, etc can protect the wire.

In FIG. 10b, a longitudinal cross section of the seat is shown, indicating that the sequences of the zigzags on the zigzag wires 8 is not random, and the high pressure contact pushers 16 have to alternate with the low pressure pushers 16, over at least two pushers, in order to generate the massage contact feeling on the occupant 20 back.

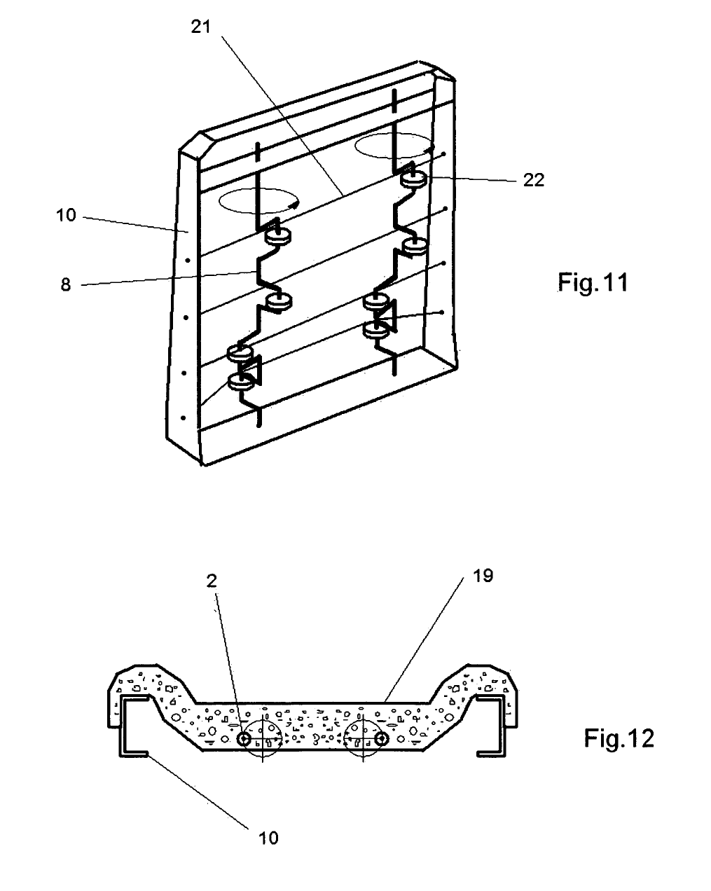

In FIG. 11, the pushers are replaced with transversal wire supports 21, anchored between the frame sides 10. The zigzag wire supports 8 are provided with compressing rollers 22 rotating around the pivoting axis of the zigzag wires, and pushing intermittently the transversal wire supports 21 against the back cover of the seat. As the picture illustrates, at this particular moment the lowest transversal wire support only is pushed by rollers, and generates pressure on the seat back, the other wires being idle in the cycle. The transversal wire supports 21 are connected to the seat frame by hooks, springs, rubber rings, plastic elements, etc, all of them providing a relative stretch elasticity during the process.

In FIG. 12, the sketch reveals the option of imbedding any of the massage systems already described into the foam pad. No back cover is necessary with this option.

### DRAWING REFERENCE NUMERAL WORKSHEET

1. Gear box
2. Massage subassembly
3. Seat frame
4. Lower bushing
5. Roller
6. Upper beam
7. Lower beam
8. Zigzag wire support (Contact components support)
9. Vertical component
10. Frame side
11. Bowden cable
12. Beck cover
13. Anchor spring
14. Contact component
15. Profile tube
16. Pusher
17. Attachment element
18. Adjusting system
19. Back pad
20. Occupant
21. Transversal wire support
22. Compressing roller

1. A massage system comprising:
a lower beam suspended and pivoting on two side vertical components articulated to the sides of the seat frame;
at least two massage subassemblies connected to actuators output shafts located on the upper beam and pivoting in the seat frame;
at least one pressure-adjusting feature attached to the seat frame and connected to said lower beam, including Bowden cable assemblies and springs;
a seat-back cover attached to the vertical components and traveling with them during pressure adjusting process.

2. The massage system according to claim 1 wherein said massage subassembly comprises:
a contact components support;
a set of contact components;
a lower bushing.

3. The massage system according to claim 1 wherein said contact components support represents a zigzag wire support with a distribution of the anchoring spot areas of the contact components in the same plane; I prefer the anchoring points to be in the same plane. However, the anchoring spots can be evenly or unevenly distributed around and along the zigzag wire in the same time;

4. The massage system according to claim 1 wherein said back cover is mounted on the vertical components and it is traveling with the massage subassemblies during the adjustment process.

5. The massage system according to claim 1 wherein said contact components support is a profile tube or rod, and transfers the rotation torque to contact components by geometric shape like square, rectangle, triangle, hexagon, etc.

6. The massage system according to claim 1 wherein said contact components can be subassemblies with protruding rollers or other features, mounted excentric with respect to the mounting hole provided for the profile tube or rod;

7. The massage system according to claim 1 wherein said contact components support is a flexible shaft with variable profile;

8. The massage system according to claim 1 wherein said contact components are provided with mounting features on each side to be assembled one over the other, the features of one side mating the geometry of the opposite side and being relatively apart on the same contact component, and generate a controlled relative position of the active zone of each contact component around and along the contact components support;

9. The massage system according to claim 1 wherein said massage subassemblies are imbedded in the foam back pad;

10. The massage system according to claim 1 wherein said lower beam is suspended directly to side Bowden cables and lower springs;

11. The massage system according to claim 1 wherein said lower beam is stretched between the upper beam and the Bowden cables directed downwards;

12. A massage system comprising:
two side zigzag wire supports placed on each side of the seat frame;
a set of pushers connected to corresponding areas of the two zigzag wire supports;

13. The massage system according to claim 12 wherein the massage effect is generated by two zigzag wire supports rotating synchronously or asynchronously, and a set of pushers moving parallel toward the occupant, and generating variable alternating pressure zones along the back seat, producing the massage effect;

14. The massage system according to claim 12 wherein said zigzag wire support represents a zigzag wire with a distribution of the anchoring spot areas of the pushers is in the same plane; I prefer the anchoring points to be in the same plane. However, the anchoring spots can be evenly or unevenly distributed around and along the zigzag wire axis in the same time;

15. The massage system according to claim 12 wherein said pushers can be a wire or a strap, a stamping, a plastic molded component, a welded component, a rubber component, a textile component, a glass component, a composite material component, etc, anchored between each of the said zigzag wire supports by hooks, snapping features, molded features, welded feature, springs, clips, holes, etc.;

16. The massage system according to claim 12 wherein said pushers are provided with a protective tube, case, envelope, etc, in order to avoid direct friction between the pushers and the back cover of the seat or back pad of the seat;

17. A massage system comprising at least two massage subassemblies mounted between the upper and the lower beam of a seat frame, without pressure adjustments system, and rotating synchronously or asynchronously, and provided or not with transversal wire supports for the seat back pad;

18. The massage system according to claim 17 wherein said massage subassembly comprises:
two contact components support represented by a zigzag wire, a profile support tube or rod, a flexible shaft with constant or variable section, etc;
a set of contact components with side mounting features to control the relative position when mounted on the contact components support, or contact subassemblies provided with rollers, sliding contact features, etc;

19. The massage system according to claim 17 wherein said transversal wire support is a wire, a plastic component, a rubber component, a welded component, a textile component etc, anchored between the seat frame sides by hooks, rubber rings, or any other elastic means, and pressing the seat back pad under the action of the corresponding contact components in rotation, represented by pressure rollers, slides, etc, and mounted on the zigzag wires.
